(19) United States
(12) Patent Application Publication
(10) Pub. No.: US 2006/0294354 A1
(43) Pub. Date: Dec. 28, 2006

(54) Image-based system maintenance

(75) Inventors: Keith A. McCall, Sammamish, WA (US); Ronald S. Woan, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Azaleos Corporation

(21) Appl. No.: 11/282,169

(22) Filed: Nov. 17, 2005

Related U.S. Application Data
(60) Provisional application No. 60/688,507, filed on Jun. 7, 2005.

(51) Int. Cl. G06F 15/177; G06F 9/24

(52) U.S. Cl. 713/1

(57) ABSTRACT

Methods and apparatuses for generating a generic system image to facilitate maintenance of one or more user-servicing processes of executing system images, and using the generic system image, in conjunction with configuration data to generate a system image having fixed, enhanced, or both, user-servicing processes, are described herein.

### CROSS-REFERENCES TO RELATED APPLICATIONS

This application claims the benefit of U.S. Provisional Application No. 60/688,507, filed on Jun. 7, 2005, entitled IMAGE-BASED SYSTEM PATCH, the specification and drawings of which are incorporated herein in full by reference.

### TECHNICAL FIELD

Embodiments of the present invention relate to the field of data processing, in particular, to maintenance of one or more user servicing processes of an executing system image, where the maintenance may include application of fixes, enhancement, or both, and the application may be performed under remote control and/or without substantial interruption of services to the one or more users.

### BACKGROUND

Continuous advancements in the speed of processors, system memory, and storage have allowed software developers to create programs of increasing complexity and usefulness, and have allowed developers to regularly enhance programs with new and useful features and/or fix any problems that might exist with their software products. Advancements in networking and client-server technologies have also made distribution of software enhancements and/or fixes easier and more readily available to software users.

Today, the distribution of such enhancements and/or fixes typically occurs within the well-known client-server architecture, over a network such as the Internet. Developers will generate the enhancements and/or fixes, and validate them for various client system configurations, taking into account the wide variety of available operating systems, such as Microsoft Windows, the multiple versions of such operating systems, as well as the wide variety of software and hardware configurations available to program users. The enhancements and/or fixes are then made available to client systems through one or more servers accessible through a network, to be downloaded either at the client's request or at the servers' prompting. The downloaded enhancements and/or fixes are then applied to the client systems either by the users or their supporting Information Technology (IT) staff.

This customary approach, however, is subject to a number of disadvantages. First and foremost, it typically requires the support of client IT staff. Further, services to the end users are often interrupted.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of the image-based system maintenance process, in accordance with various embodiments;

FIGS. 2a-2e illustrate multiple computer system configurations for implementation of the image-based system maintenance process, in accordance with various embodiments of the invention;

FIG. 3 illustrates a flow chart view of selected operations needed to maintain processes of a system image deployed in a computer system configuration like that shown in FIG. 2d, in accordance with various embodiments of the invention;

FIG. 4 illustrates an overview of the generic system image generation and deployment process, in accordance with various embodiments of the invention;

FIG. 5 illustrates a flow chart view of selected operations needed to generate and deploy a generic system image, in accordance with various embodiments; and

FIG. 6 illustrates an example computer system suitable for use to practice the client and/or server aspect of the present invention, in accordance with various embodiments.

### DETAILED DESCRIPTION OF ILLUSTRATIVE EMBODIMENTS

Illustrative embodiments of the present invention include but are not limited to methods and apparatuses for maintaining processes in an executing system image by generating a generic system image having fixed up, enhanced, or both, versions of the processes, deploying the generic system image, localizing the generic system image, and then replacing the executing system image with the localized system image, thereby allowing the processes to be maintained with little or no interruption to the services offered by the processes.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

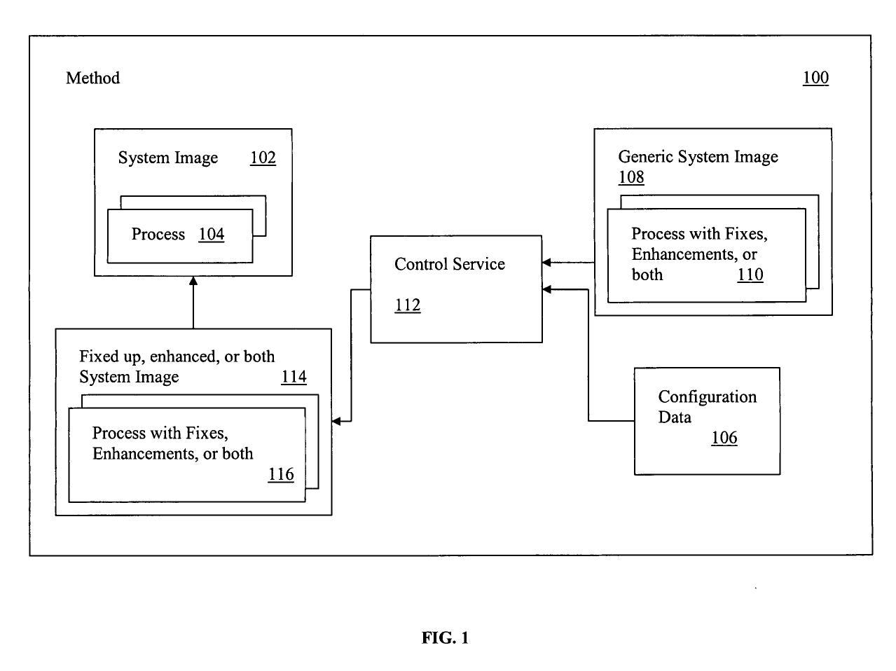

FIG. 1 illustrates an overview of the software maintenance process/method of the present invention, in accordance with various embodiments. As illustrated, method 100 enables one or more processes 104 of executing system image 102, servicing one or more users, to be maintained (i.e. fixed, enhanced, or both), with little or no interruption to servicing the one or more users. The one or more processes 104 may be processes of any sort of application or operating system. In some embodiments, the one or more processes 104 may be processes of an email service, such as Microsoft Exchange, or a control service, such as a domain controller. In various embodiments, one or more system images 102 may have email service processes 104, while a second system image 102 may implement a controller service process 104 to manage control of and maintenance of the system images 102 executing the email service processes 104.

In various embodiments, maintenance of a process, i.e. its fixes, enhancements, or both, may be received, either via a networking fabric, a storage medium, or through some other means, having a generic system image 108 integrated with a fixed up, enhanced or both, version of the process. The creation and deployment of the generic system image 108 having fixed up, enhanced, or both, versions of the processes to be maintained, will be discussed in greater detail below.

The phrase “generic system image” 108 as used herein refers to a system image that has not been configured for a particular local operating environment. The system image is considered generic because it is to be deployed on a number of computer systems in a number of enterprises, each computer system receiving exactly the same generic system image 108, and the expectation is in each case, the generic system image 108 will be localized, i.e. configured with local configuration data, before the system image is used on the particular computer system of the particular enterprise.

As illustrated, the generic system image 108 has one or more processes 110, corresponding in some embodiments to the one or more processes 104 of system image 102, the one or more processes 110 having been updated with fixes, enhancements, or both, in a method to be described below.

As is further illustrated, method 100 includes applying configuration data 106 to the generic system image 108 by a control service 112 to localize the generic system image. Configuration data 106 may include data items such as the system name, network address, memory size, processes priorities, and so forth. Application of configuration data 106 to the generic system image 108 facilitates the generation of a fixed up, enhanced, or both, system image 114 that differs from the generic system image 108.

In some embodiments, a control service 112 receives the generic system image 108, retrieves the configuration data 106, and sends the configuration data 106 and the generic system image 108 to a computer system or partition of a computer system having an executing system image 102 to generate the fixed up, enhanced, or both, system image 114 to replace the previous executing system image having the processes to be maintained. Application of the configuration data 106 to the generic system image 108 and the consequent generation of the fixed up, enhanced, or both, system image 114 occur upon reboot of the previous executing system image 102. Upon completion of reboot, the previously executing system image 102 is thus replaced with the localized system image 114 having the fixed up, enhanced, or both, versions of the processes to be maintained. In various embodiments, partition switching may be effectuated in a relatively short amount of time that is not noticeable to a typical user of a process being maintained. Resultantly, the process may be effectively maintained without appreciable interruption to the service.

In some embodiments (not illustrated), control service 112 may itself constitute one of the one or more processes on an executing second system image differing from system image 102, the second system image configured in accordance with a second set of configuration data differing from configuration data 106 by zero, one, or more configuration data values. Additionally, control service 112 may receive a second generic system image (not illustrated) having a fixed up, enhanced, or both, version of the control service 112. Upon retrieving the second set of configuration data and receiving the second generic system image, a second, fixed up, enhanced, or both, system image to replace the second system image is generated in the same fashion as described above. Also, as will be discussed in greater detail below, the second system image of control service 112 may be implemented on a different computer system from system image 102, or may be implemented on the same computer system using two or more partitions of the system.

Also, as illustrated, the fixed up, enhanced, or both, system image 114 has one or more processes 116, identical to the one or more processes 104 except for the addition of fixes, enhancements, or both. After the fixed up, enhanced, or both, system image 114 has been generated in the manner described above, the optional step of validation of the fixed up, enhanced, or both, system image 114 may, in some embodiments, be performed (not illustrated). Should the validation be successful, the fixed up, enhanced or both, system image 114 and its one or more processes 116 will begin to execute and service the one or more users, replacing the execution of system image 102. Upon replacement, in some embodiments, the system image maintenance process will continue to perform the same operations on other system images 102 until such a point as the maintenance process may be considered complete. This approach is discussed in further detail below.

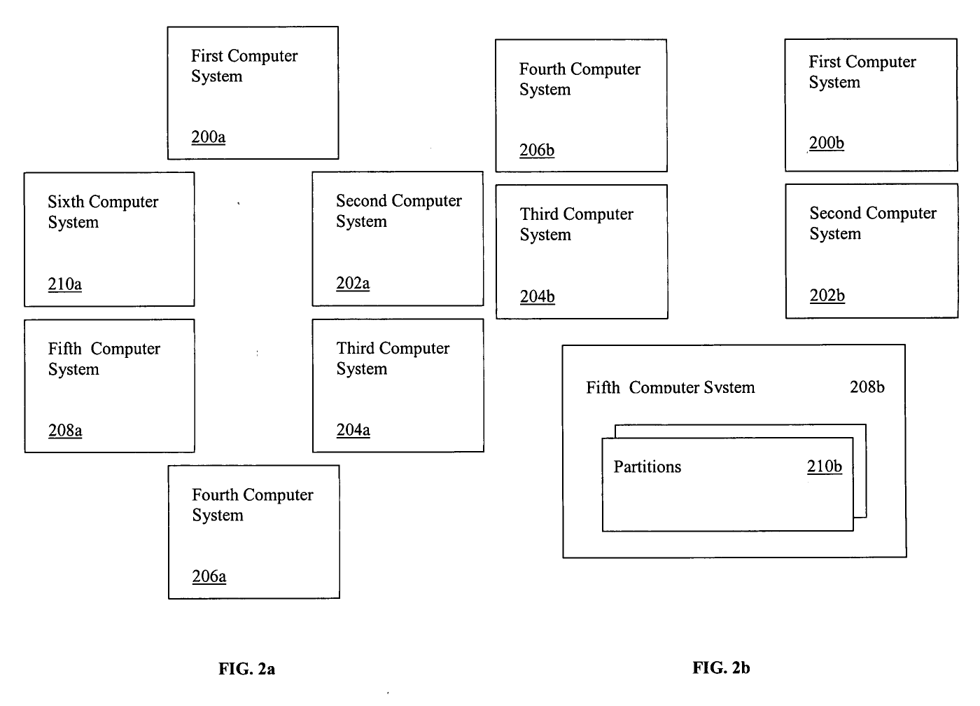

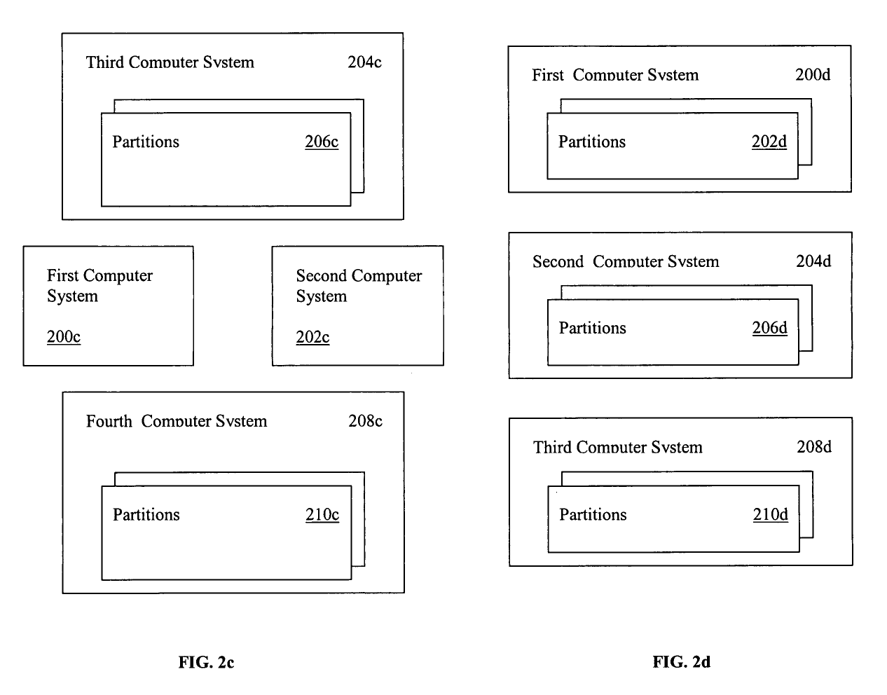

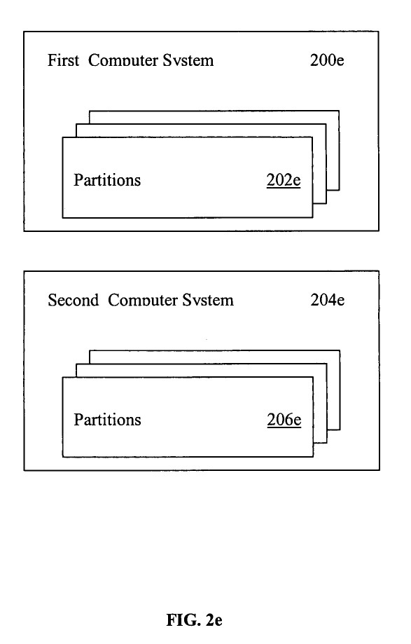

FIGS. 2a-2e illustrate multiple computer system configurations for implementation of the system image maintenance process, in accordance with various embodiments of the invention. The series of embodiments illustrated by FIGS. 2a-2e is by no means exhaustive.

FIG. 2a illustrates a series of embodiments comprising six distinct computer systems, first computer system 200a, second computer system 202a, third computer system 204a, fourth computer system 206a, fifth computer system 208a, and sixth computer system 210a. First computer system 200a may perform the operation of executing system image 102. Second computer system 202a may perform the operation of applying configuration data 106. Third computer system 204a may perform the operation of executing the fixed up, enhanced, or both, system image 114. Fourth computer system 206a may perform the operation of executing a second system image. Fifth computer system 208a may perform the operation of applying the second set of configuration data. And lastly, sixth computer system 210a may perform the operation of executing the second fixed up, enhanced, or both, system image.

FIG. 2b illustrates a series of embodiments comprising five distinct computer systems, first computer system 200b, second computer system 202b, third computer system 204b, fourth computer system 206b, and fifth computer system 208b, the fifth computer system 208b having at least two partitions 210b.

For example, in various embodiments, first computer system 200b may perform the operation of executing system image 102. Second computer system 202b may perform the operation of applying configuration data 106. Third computer system 204b may perform the operation of executing the fixed up, enhanced, or both, system image 114. Fourth computer system 206b may perform the operation of executing a second system image. And lastly, fifth computer system 208b may perform the operations of applying the second set of configuration data on a first of its at least two partitions 210b, and of executing the second fixed up, enhanced, or both, system image on a second of its at least two partitions 210b.

Alternatively, first computer system 200b may perform the operation of executing system image 102. Second computer system 202b may perform the operation of applying configuration data 106. Third computer system 204b may perform the operation of executing the fixed up, enhanced, or both, system image 114. Fourth computer system 206b may perform the operation of applying the second set of configuration data. And lastly, fifth computer system 208b may perform the operations of executing a second system image on a first of its at least two partitions 210b, and of executing the second fixed up, enhanced, or both, system image on a second of its at least two partitions 210b.

FIG. 2c illustrates a series of embodiments comprising four distinct computer systems, first computer system 200c, second computer system 202c, third computer system 204c, the third computer system 204c having at least two partitions 206c, and fourth computer system 208c, the fourth computer system 208c having at least two partitions 210c.

For example, in various embodiments, first computer system 200c may perform the operation of executing system image 102. Second computer system 202c may perform the operation of executing a second system image. Third computer system 204c may perform the operations of applying configuration data 106 on a first of its at least two partitions 206c, and of executing the fixed up, enhanced, or both, system image 114 on a second of its at least two partitions 206c. And lastly, fourth computer system 208c may perform the operations of applying the second set of configuration data on a first of its at least two partitions 210c, and of executing the second fixed up, enhanced, or both, system image on a second of its at least two partitions 210c.

Alternatively, first computer system 200c may perform the operation of applying configuration data 106. Second computer system 202c may perform the operation of applying the second set of configuration data. Third computer system 204c may perform the operations of executing system image 102 on a first of its at least two partitions 206c, and of executing the fixed up, enhanced, or both, system image 114 on a second of its at least two partitions 206c. And lastly, fourth computer system 208c may perform the operations of executing a second system image on a first of its at least two partitions 210c, and of executing the second fixed up, enhanced, or both, system image on a second of its at least two partitions 210c.

FIG. 2d illustrates a series of embodiments comprising three distinct computer systems, first computer system 200d, the first computer system 200d having at least two partitions 202d, second computer system 204d, the second computer system 204d having at least two partitions 206d, and third computer system 208d, the third computer system 208d having at least two partitions 210d.

For example, in various embodiments, first computer system 200d may perform the operations of applying configuration data 106 on a first of its at least two partitions 202d, and of executing the fixed up, enhanced, or both, system image 114 on a second of its at least two partitions 202d. Second computer system 204d may perform the operations of executing system image 102 on a first of its at least two partitions 206d, and of executing the second system image on a second of its at least two partitions 206d. And lastly, third computer system 208d may perform the operations of applying the second set of configuration data on a first of its at least two partitions 210d, and of executing the second fixed up, enhanced, or both, system image on a second of its at least two partitions 210d.

Alternatively, first computer system 200d may perform the operations of applying configuration data 106 on a first of its at least two partitions 202d, and of executing the fixed up, enhanced, or both, system image 114 on a second of its at least two partitions 202d. Second computer system 204d may perform the operations of executing system image 102 on a first of its at least two partitions 206d, and of executing the second system image on a second of its at least two partitions 206d. And lastly, third computer system 208d may perform the operations of applying the second set of configuration data on a first of its at least two partitions 210d, and of executing the second fixed up, enhanced, or both, system image on a second of its at least two partitions 210d.

FIG. 2e illustrates a series of embodiments comprising two distinct computer systems, first computer system 200e, the first computer system 200e having at least three partitions 202e, and second computer system 204e, the second computer system 204e having at least three partitions 206e.

For example, in various embodiments, first computer system 200e may perform the operations of executing system image 102 on a first of its at least three partitions 202e, of applying configuration data 106 on a second of its at least three partitions 202e, and of executing the fixed up, enhanced, or both, system image 114 on a third of its at least three partitions 202e. Further, second computer system 204e may perform the operations of executing the second system image on a first of its at least three partitions 206e, applying the second set of configuration data on a second of its at least three partitions 206e, and of executing the second fixed up, enhanced, or both, system image on a third of its at least three partitions 206e.

Alternatively, first computer system 200e may perform the operations of executing system image 102 on a first of its at least three partitions 202e, of applying configuration data 106 on a second of its at least three partitions 202e, and of executing the second system image on a third of its at least three partitions 202e. Further, second computer system 204e may perform the operations of executing the fixed up, enhanced, or both, system image 114 on a first of its at least three partitions 206e, applying the second set of configuration data on a second of its at least three partitions 206e, and of executing the second fixed up, enhanced, or both, system image on a third of its at least three partitions 206e.

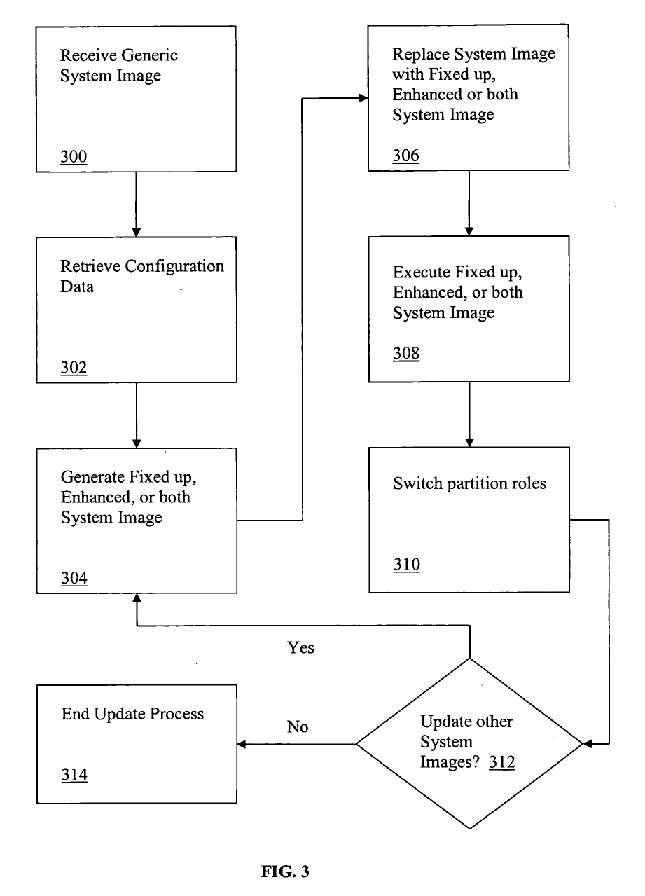

FIG. 3 illustrates a flow chart view of selected operations needed to maintain processes of a system image deployed in a computer system configuration like that shown in FIG. 2d, in accordance with various embodiments of the invention. These operations need not however, be performed in a computer system configuration like that shown in FIG. 2d. Rather, the operations may be performed in any sort of computer system configuration depicted herein or known in the art.

The system image maintenance process, as illustrated, begins with the receipt of a generic system image 108, block 300 by a computer system or partition of a computer system executing a control service 112. As shown in FIG. 2d, a first partition 202d of the first computer system 200d can receive the generic system image 108, block 300, because the first partition 202d is performing the operation of executing a second system image, the second system image, as described above, executing a control service 112.

Upon receipt of the generic system image 108, block 300, control service 112 of the executing second system image may retrieve configuration data, block 302.

The system image maintenance process may then proceed in the manner described above to generate a fixed up, enhanced, or both, system image 114, block 304. For example, a second partition 206d of the second computer system 204d may reboot at the behest of control service 112. During its reboot, the second partition 206d may then have applied configuration data 106 to the generic system image 108, which the second partition 206d may receive from control service 112, and in so having applied can have generated a fixed up, enhanced, or both system image 114, block 304.

Upon having generated the fixed up, enhanced, or both, system image 114, block 304, second partition 206d then replaces system image 102 with the fixed up, enhanced, or both system image 114, block 306.

Following its reboot to the replacement fixed up, enhanced, or both, system image 114, the second partition 206d of second computer system 204d may execute the fixed up, enhanced, or both, system image 114, block 308.

Optionally, and not shown here, computer system 204d may then validate the fixed up, enhanced, or both, system image 114 now executing on its second partition 206d to ensure that the replacement system image is functioning properly.

Following the optional validation, the system image maintenance process, in some embodiments, proceeds to switch the partition roles, block 310, of a first partition 206d and of the second partition 206d of the second computer system 204d. Thus, when the control service 112 determines if there are other system images in need of update, the first partition 206d, rather than the second partition 206d, may receive the generic system image 108 and configuration data 106.

Upon completion of the above operations, in some embodiments, control service 112 determines if there are other system images 102 having one or more user-servicing processes in need of fixes, enhancements, or both, block 312, in the manner described above. In FIG. 2d, for example, system images 102 on the first partition 206d of the second computer system 204d and on a first partition 210d and a second partition 210d of the third computer system 208d, could all still need to be updated with the generic system image 108. The system image maintenance process could then proceed again to generate a fixed up, enhanced, or both, system image 114, block 304 for each of the other system images 102 on the remaining partitions, and could proceed in sequence through the other above mentioned operations.

Upon updating each of the system images 102 with the generic system image 108, the update process managed by control service 112 terminates, block 314.

FIG. 3 also illustrates the system image maintenance process for the second system image, the second system image having a control service process 112. The same operations and same sequence described and illustrated herein could also be followed to update the second system image. In FIG. 2d, however, a second partition 202d of first computer system 200d, followed by a first partition 202d of first computer system 200d could be updated.

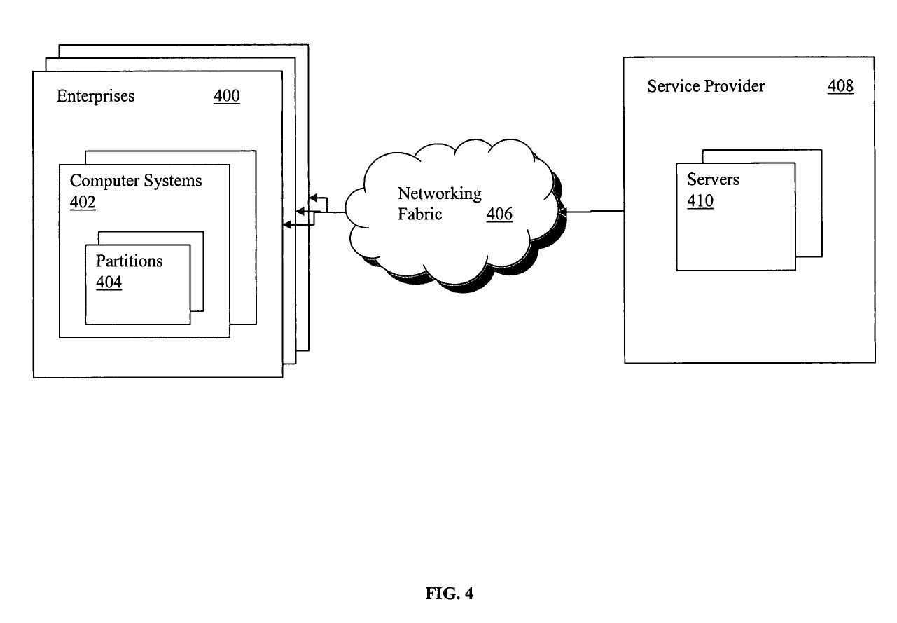

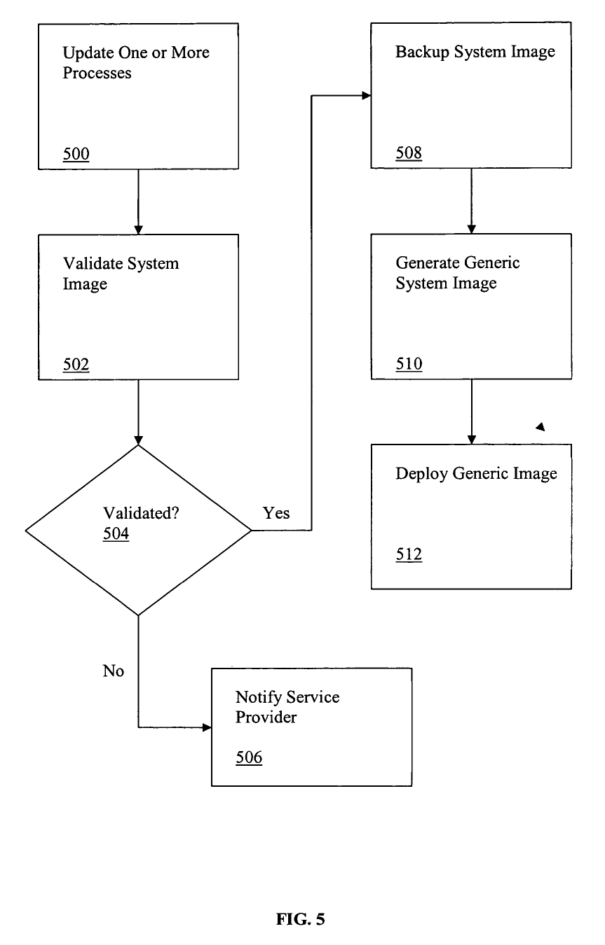

FIG. 4 illustrates an overview of the generic system image generation and deployment process, in accordance with various embodiments of the invention. As illustrated, service provider 408 has one or more servers 410 which may operate to generate generic system images 108 to be deployed to one or more enterprises 400. The operations facilitating the generation of generic system image 108 are illustrated in FIG. 5 and described in greater detail below. The one or more enterprises 400 receiving a generic system image 108 may have one or more computer systems 402 which may be configured in one of the ways illustrated by FIGS. 2a-2e or in some other fashion known in the art. Additionally, in some embodiments, computer system 402 may have one or more partitions 404 which may, in some embodiments, be employed to perform the operations of the system image maintenance process described above and depicted in FIGS. 1 and 3.

Upon generation of a generic system image 108 on its one or more servers 410, service provider 408 may deploy the image to the one or more enterprises. As illustrated, in various embodiments, service provider 408 makes use of networking fabric 406 to deploy a generic system image 108 to one or more enterprises 400. The networking fabric 406 may be any one of a number of networking fabrics, such as a LAN, a WAN, or the Internet.

In other embodiments, not illustrated, deployment may utilize one or more storage mediums, such as CDs or DVDs to store the generic system image 108 by copying the generic system image 108 from the one or more servers 410 of service provider 408 onto the storage media. The storage media may then be sent to one or more enterprises by the service provider, directly or indirectly. Upon receipt of the storage media, the enterprise may then load the media onto the one or more computer systems 402 executing control service processes 112. The system image maintenance process then may proceed in the manner described above and depicted in FIGS. 1 and 3.

Similarly, not illustrated, and described in further detail below, the generic system image 108 may consist only of the differences between the system image 102 and generic system image 108 described and depicted above. The differences may comprise a byte differential capable of being applied to system image 102 to generate the full generic system image 108 described and depicted above. In this way, the amount of data necessary to transmit for the operations of deployment is lessened.

FIG. 5 illustrates a flow chart view of selected operations needed to generate and deploy a generic system image 108, in accordance with various embodiments. As illustrated, the generic system image generation process begins by updating one or more user-servicing processes, block 500, with one or more fixes, enhancements, or both. As discussed above, the one or more processes may be a process of an application, such as an email service or a control service, or may be a process of an operating system. The one or more processes receiving the update may be executing as part of a system image of a server 410 of a service provider 408.

Upon completion of updating one or more processes, block 500, the generic system image generation process proceeds to validate the system image having the now fixed, enhanced, or both, one or more processes, block 502, to ensure that the system image is a properly functioning system image and to ensure that the fixed, enhanced, or both, one or more processes properly function.

If not validated, block 504, the server 410 executing the generic system image generation process terminates the process and notifies service provider 408 of the unsuccessful result. If validated, block 504, the generic system image generation process proceeds to the following operations described herein to generate and deploy the generated generic system image.

As illustrated, in some embodiments, the validated system image is then backed up, block 508, by the server 410 in which these operations occur.

Upon completion of the back up operation, a generic system image 108 is then generated, block 510. The generic system image 108 may be a clone of the validated and backed up system image having the fixed, enhanced, or both, one or more processes. The system image is “generic” because it may be capable of deployment to one or more computer systems 402 of one or more enterprises 400 where it can be localized by applying configuration data of the one or more computer systems 402 to generate a fixed up, enhanced, or both, system image 114 through the operations described and illustrated above.

In some embodiments, as mentioned above, the generic system image 108 generated may be simply a byte differential between the validated, updated system image of the server 410 and the system image 102 of the one or more computer systems 402.

Upon completing the generation of the generic system image 108, whether creating a clone or a byte differential, the service provider 408 proceeds to deploy the generic system image, block 512, in one of the fashions described above, such as utilizing a networking fabric 406 or storage media (not pictured), or in some other fashion.

Upon completion of the deployment process, one or more enterprises 400 receive the generic system image 108 through control services 112 of one or more of their computer systems 402.

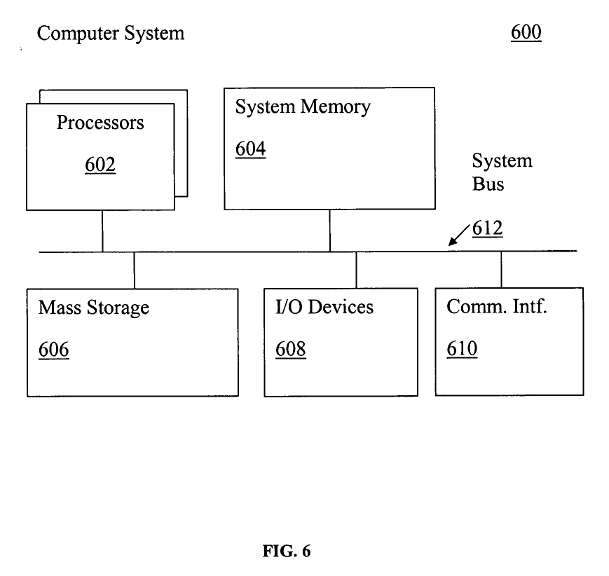

FIG. 6 illustrates an example computer system suitable for use to practice the client and/or server aspect of the present invention, in accordance with various embodiments. As shown, computer system 600 includes one or more processors 602 and system memory 604. Additionally, computer system 600 includes input/output devices 608 (such as keyboard, cursor control, and so forth). The elements are coupled to each other via system bus 612, which represents one or more buses. In the case of multiple buses, they are bridged by one or more bus bridges (not shown). Each of these elements performs its conventional functions known in the art. In particular, system memory 604 and mass storage 606 are employed to store a working copy of the system images (including in some cases, the control service) and a permanent copy of the programming instructions implementing the system images, respectively. The permanent copy of the instructions implementing the system images may be loaded into mass storage 606 in the factory, or in the field, through a distribution medium (not shown) or through communication interface 610 (from a distribution server such as server 410). The constitution of these elements 602-612 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. A method comprising:
executing a system image including one or more processes to service one or more users, the system image having been configured in accordance with a set of configuration data;
applying the configuration data to a generic system image having fixes, enhancements, or both, said fixes, enhancements, or both, applied to at least one of the one or more processes to generate a fixed up, enhanced, or both, system image, without interruption to said executing of the system image to service the one or more users; and
executing the fixed up, enhanced, or both, system image to service the one or more users, replacing said execution of the system image to service the one or more users.

2. The method of claim 1, wherein said executing of the system image, said applying of the configuration data, and said executing of the fixed up, enhanced, or both, system image are all performed on different computer systems.

3. The method of claim 1, wherein at least two of said executing of the system image, said applying of the configuration data, and said executing of the fixed up, enhanced, or both, system image are performed on the same computer system, employing at least two partitions of the computer system.

4. The method of claim 3, wherein said executing of the system image and said executing of the fixed up, enhanced, or both, system image are performed on the same computer system, in a first and a second partition of the computer system, respectively, the first and second partitions being different partitions.

5. The method of claim 3, wherein said applying of the configuration data and said executing of the fixed up, enhanced, or both, system image are performed on the same computer system, in a first and a second partition of the computer system, respectively, the first and second partitions being different partitions.

6. The method of claim 1, wherein said executing of the system image, said applying of the configuration data, and said executing of the fixed up, enhanced, or both, system image are all performed on the same computer system, employing three partitions of the computer system.

7. The method of claim 1, further comprising receiving the generic system image having fixes, enhancements, or both, applied to at least one of the one or more processes, and retrieving the configuration data.

8. The method of claim 7, wherein the receiving, retrieving, and applying are all performed by a control service implemented with a second one or more processes that are separate and distinct from the one or more processes executed to service the one or more users.

9. The method of claim 8, wherein the control service is a part of an executing second system image configured in accordance with a second set of configuration data, and the method further comprises receiving a second generic system image having a fixed up, enhanced, or both, version of the control service, applying the second set of configuration data to the second generic system image to generate a second fixed up, enhanced, or both, system image, and executing the second fixed up, enhanced, or both, system image, in lieu of the second system image, wherein the second system image and the system image set forth in claim 1 are different system images, the second set of configuration data and the configuration data set forth in claim 1 are different sets of configuration data having zero, one or more common configuration data values, and the second generic system image and the generic system image set forth in claim 1 are different generic system images.

10. The method of claim 9, wherein said executing of the second system image, said applying of the second set of configuration data, and said executing of the second fixed up, enhanced, or both, system image are all performed on different computer systems.

11. The method of claim 10, wherein at least one of said executing of the system image, said applying of the configuration data, and said executing of the fixed up, enhanced, or both, system image is performed on one of said different computer systems, employing a plurality of partitions on the said one the different computer systems.

12. The method of claim 9, wherein at least two of said executing of the second system image, said applying of the second set of configuration data, and said executing of the second fixed up, enhanced, or both, system image are performed on the same computer system, employing at least two partitions of the computer system.

13. The method of claim 12, wherein at least one of said executing of the system image, said applying of the configuration data, and said executing of the fixed up, enhanced, or both, system image is performed on the same computer system, employing at least one additional partition on the computer system.

14. The method of claim 9, wherein said executing of the second system image and said executing of the second fixed up, enhanced, or both, system image are performed on the same computer system, in a first and a second partition of the computer system, respectively, the first and second partitions being different partitions.

15. The method of claim 14, wherein at least one of said executing of the system image, said applying of the configuration data, and said executing of the fixed up, enhanced, or both, system image is performed on the same computer system, employing at least an additional third partition on the computer system.

16. The method of claim 9, wherein said applying of the second set of configuration data and said executing of the second fixed up, enhanced, or both, system image are performed on the same computer system, in a first and a second partition of the computer system, respectively, the first and second partitions being different partitions.

17. The method of claim 16, wherein at least one of said executing of the system image, said applying of the configuration data, and said executing of the fixed up, enhanced, or both, system image is performed on the same computer system, employing at least an additional third partition on the computer system.

18. The method of claim 9, wherein said executing of the second system image, said applying of the second set of configuration data, and said executing of the second fixed up, enhanced, or both, system image are all performed on the same computer system, employing three partitions of the computer system.

19. The method of claim 18, wherein at least one of said executing of the system image, said applying of the configuration data, and said executing of the fixed up, enhanced, or both, system image is performed on the same computer system, employing at least one additional partition on the computer system.

20. The method of claim 1, wherein the one or more processes comprise a process of an application, and the process of the application contained in the generic system image has one or more fixes, enhancements, or both applied.

21. The method of claim 20, wherein the application provides email service.

22. The method of claim 1, wherein the one or more processes comprise a process of an operating system, and the process of the operating system contained in the generic system image has one or more fixes, enhancements, or both applied.

23. An apparatus comprising:
At least one storage unit having stored thereon programming instructions designed to enable the apparatus to
execute a system image including one or more processes to service one or more users, the system image having been configured in accordance with a set of configuration data;
apply the configuration data to a generic system image having fixes, enhancements, or both, said fixes, enhancements, or both, applied to at least one of the one or more processes to generate a fixed up, enhanced, or both, system image, without interruption to said executing of the system image to service the one or more users;
execute the fixed up, enhanced, or both, system image to service the one or more users, replacing said execution of the system image to service the one or more users; and
at least one processor coupled to said at least one storage unit to execute said programming instructions.

24. The apparatus of claim 23, wherein said executing of the system image, said applying of the configuration data, and said executing of the fixed up, enhanced, or both, system image are all performed on different computer systems.

25. The apparatus of claim 23, wherein at least two of said executing of the system image, said applying of the configuration data, and said executing of the fixed up, enhanced, or both, system image are performed on the same computer system, employing at least two partitions of the computer system.

26. The apparatus of claim 23, wherein said executing of the system image, said applying of the configuration data, and said executing of the fixed up, enhanced, or both, system image are all performed on the same computer system, employing three partitions of the computer system.

27. The apparatus of claim 23, wherein the apparatus further comprises programming instructions designed to enable the apparatus to
receive the generic system image having fixes, enhancements, or both, applied to at least one of the one or more processes; and
retrieve the configuration data.

28. The apparatus of claim 27, wherein the receiving, retrieving, and applying are all performed by a control service implemented with a second one or more processes that are separate and distinct from the one or more processes executed to service the one or more users.

29. The apparatus of claim 28, wherein the control service is a part of an executing second system image configured in accordance with a second set of configuration data, and the apparatus further comprises programming instructions designed to enable the apparatus to
receive a second generic system image having a fixed up, enhanced, or both, version of the control service,
apply the second set of configuration data to the second generic system image to generate a second fixed up, enhanced, or both, system image, and
execute the second fixed up, enhanced, or both, system image, in lieu of the second system image, wherein the second system image and the system image set forth in claim 23 are different system images, the second set of configuration data and the configuration data set forth in claim 23 are different sets of configuration data having zero, one or more common configuration data values, and the second generic system image and the generic system image set forth in claim 23 are different generic system images.

30. The apparatus of claim 29, wherein said executing of the second system image, said applying of the second set of configurable data, and said executing of the second fixed up, enhanced, or both, system image are all performed on different computer systems.

31. The apparatus of claim 29, wherein at least two of said executing of the second system image, said applying of the second set of configuration data, and said executing of the second fixed up, enhanced, or both, system image are performed on the same computer system, employing at least two partitions of the computer system.

32. The apparatus of claim 29, wherein said executing of the second system image, said applying of the second set of configurable data, and said executing of the second fixed up, enhanced, or both, system image are all performed on the same computer system, employing three partitions of the computer system.

33. A method comprising:
applying fixes, enhancements, or both to one or more processes of a system image to generate a fixed up, enhanced, or both, system image;
validating the fixed up, enhanced, or both, system image;
if validated, generating a generic system image from said fixed up, enhanced, or both, system image, said generic system image capable of a deployment on one or more computer systems, the deployment including
applying configuration data to the generic system image to generate a second fixed up, enhanced, or both, system image, said second fixed up, enhanced, or both, system image and said fixed up, enhanced, or both, system image differing by zero, one, or more configuration data values; and deploying the generic system image to the one or more computer systems.

34. The method of claim 33, wherein said deploying comprises transferring the generic system image to the one or more computer systems via a networking fabric.

35. The method of claim 34, wherein said transferring comprises transporting only the differences between the generic system image and a second system image of the one or more computer systems.

36. The method of claim 33, wherein said deploying comprises transferring the generic system image to the one or more computer systems via one or more storage mediums storing thereon the generic system image.

37. The method of claim 36, wherein said transferring comprises transporting only the differences between the generic system image and a second system image of the one or more computer systems.

38. An apparatus comprising:
at least one storage unit having stored thereon programming instructions designed to enable the apparatus to
apply fixes, enhancements, or both, to one or more processes of a system image to generate a fixed up, enhanced, or both, system image;
validate the fixed up, enhanced, or both, system image;
if validated, generate a generic system image from said fixed up, enhanced, or both, system image, said generic system image capable of a deployment on one or more computer systems, the deployment comprising
applying configuration data to the generic system image to generate a second fixed up, enhanced, or both, system image, said second fixed up, enhanced, or both, system image and said fixed up, enhanced, or both, system image differing by zero, one, or more configuration data values;
deploy the generic system image to the one or more computer systems; and
at least one processor coupled to said at least one storage unit to execute said programming instructions.

39. The apparatus of claim 38, wherein said deploying comprises transferring the generic system image to the one or more computer systems via a networking fabric.

40. The apparatus of claim 39, wherein said transferring comprises transporting only the differences between the generic system image and a second system image of the one or more computer systems.

41. The apparatus of claim 38, wherein said deploying comprises transferring the generic system image to the one or more computer systems via one or more storage mediums storing thereon the generic system image.

42. The apparatus of claim 41, wherein said transferring comprises transporting only the differences between the generic system image and a second system image of the one or more computer systems.
